(19) United States
(12) Patent Application Publication
(10) Pub. No.: US 2004/0030055 A1
(43) Pub. Date: Feb. 12, 2004

(54) Hydrogenated vinyl aromatic-diene nitrile rubber

(76) Inventor: Sharon X Guo, Stratford (CA)

Correspondence Address: BAYER POLYMERS LLC, 100 BAYER ROAD, PITTSBURGH, PA, 15205, US

(21) Appl. No.: 10/275,673

(22) PCT Filed: May 1, 2001
(86) PCT No.: PCT/CA01/00601

(30) Foreign Application Priority Data
May 12, 2000 (CA) 2,308,675

(51) Int. Cl. C08F 120/44

(52) U.S. Cl. 525/329.1

(57) ABSTRACT

Polymers of a conjugated diene, an unsaturated nitrile and a vinyl aromatic compound are selectively hydrogenated to reduce ethylenic carbon-carbon double bonds, without also reducing nitrile groups and aromatic carbon-carbon double bonds, preferably using a rhodium-containing compound as catalyst. The hydrogenated polymers are novel and display valuable properties.

The present invention relates to polymers that are composed of a vinyl aromatic compound, a conjugated diene and a nitrile and that have been selectively hydrogenated to reduce ethylenic carbon-carbon double bonds without concomitant reduction of aromatic carbon-carbon double bonds and nitrile groups. The invention also relates to a process for selectively hydrogenating such a polymer.

### BACKGROUND OF THE INVENTION

Polymers formed by polymerisation of a vinyl aromatic monomer, a conjugated diene and an unsaturated nitrile are known. These polymers contain ethylenic carbon-carbon double bonds. Such polymers, composed of styrene, 1,3-butadiene and acrylonitrile, are commercially available from Bayer under the trademarks Krylene VPKA 8802 and Krylene VPKA 8683. A process has been found for the selective hydrogenation of the ethylenic carbon-carbon double bonds. It has also been found that the product of the selective hydrogenation differs surprisingly from the unhydrogenated polymer in several valuable properties.

### SUMMARY OF THE INVENTION

In one aspect the invention provides a polymer of a conjugated diene, an unsaturated nitrile and a vinyl aromatic compound that has been selectively hydrogenated to reduce ethylenic carbon-carbon double bonds without hydrogenating nitrile groups and aromatic carbon-carbon double bonds.

In another aspect the invention provides a process which comprises selectively hydrogenating a polymer of a conjugated diene, an unsaturated nitrile and a vinyl aromatic compound to reduce ethylenic carbon-carbon double bonds without concomitant reduction of nitrile groups and aromatic carbon-carbon double bonds.

### DESCRIPTION OF THE PREFERRED EMBODIMENTS

Many conjugated dienes are used in nitrile rubbers and these may all be used in the present invention. Mention is made of 1,3-butadiene, isoprene, 2,3-dimethyl-1,3-butadiene, 1,3-pentadiene and piperylene, of which 1,3-butadiene is preferred.

The nitrile is normally acrylonitrile or methacrylonitrile or α-chloroacrylonitrile, of which acrylonitrile is preferred.

The vinyl aromatic compound can be, for example, styrene, α-methylstyrene or a corresponding compound bearing an alkyl or a halogen substituent, or both, on the phenyl ring, for instance, a p-C₁-C₆ alkylstyrene such as p-methylstyrene or a bromo-substituted p-methylstyrene.

The conjugated diene usually constitutes about 50 to about 75% of the polymer, the nitrile usually constitutes about 10 to 50%, preferably about 10 to 30% of the polymer and the vinyl aromatic compound about 5 to about 30%, preferably 10 to 20%, these percentages being by weight. The polymer may also contain an amount, usually not exceeding about 10%, of another copolymerisable monomer, for example, an ester of an unsaturated acid, say ethyl, propyl or butyl acrylate or methacrylate, or a carboxylic acid, for example acrylic, methacrylic, ethacrylic, crotonic, maleic (possibly in the form of its anhydride), fumaric or itaconic acid. The polymer preferably is a solid that has a molecular weight in excess of about 100,000, most preferably in excess of about 200,000.

The polymer that is to be hydrogenated can be made in known manner, by emulsion or solution polymerisation, resulting in a statistical polymer. The polymer will have a backbone composed entirely of aliphatic carbon atoms. It will have some vinyl side-chains, caused by 1,2-addition of the conjugated diene during the polymerisation. It will also have ethylenic double bonds in the backbone from 1,4-addition of the diene. Some of these double bonds will be in the cis and some in the trans orientation. These ethylenic carbon-carbon double bonds are selectively hydrogenated by the process of the invention, without concomitant hydrogenation of the nitrile and aromatic carbon-carbon double bonds present in the polymer.

The preferred vinyl aromatic compound is styrene and the preferred conjugated diene is butadiene. The invention will be described, by way of example, with reference to styrene-butadiene-nitrile rubber (SNBR) and to hydrogenated styrene-butadiene-nitrile rubber (HSNBR) but it should be appreciated that the description applies also to rubber in which the vinyl aromatic compound is other than styrene and the conjugated diene is other than butadiene, unless the context requires otherwise.

The selective hydrogenation can be achieved by means of a rhodium-containing catalyst. The preferred rhodium catalyst is of the formula:

(RₘB)₁RhXₙ

in which each R is a C₁-C₈-alkyl group, a C₄-C₈-cycloalkyl group a C₆-C₁₅-aryl group or a C₇-C₁₅-aralkyl group, B is phosphorus, arsenic, sulfur, or a sulphoxide group S=0, X is hydrogen or an anion, preferably a halide and more preferably a chloride or bromide ion, 1 is 2, 3 or 4, m is 2 or 3 and n is 1, 2 or 3, preferably 1 or 3. Preferred catalysts are tris-(triphenylphosphine)-rhodium(I)-chloride, tris(triphenylphosphine)-rhodium(III)-chloride and tris-(dimethylsulphoxide)-rhodium(III)-chloride, and tetrakis-(triphenylphosphine)-rhodium hydride of formula ((C₆H₅)₃P)₄RhH, and the corresponding compounds in which triphenylphosphine moieties are replaced by tricyclohexylphosphine moieties. The catalyst can be used in small quantities. An amount in the range of 0.01 to 1.0% preferably 0.03% to 0.5%, most preferably 0.06% to 0.12% especially about 0.08%, by weight based on the weight of polymer is suitable.

The rhodium catalyst is preferably used with a co-catalyst. Suitable co-catalysts include ligands of formula RₘB, where R, m and B are as defined above, and m is preferably 3. Preferably B is phosphorus, and the R groups can be the same or different. Thus there can be used a triaryl, trialkyl, tricycloalkyl, diaryl monoalkyl, dialkyl monoaryl diaryl monocycloalkyl, dialkyl monocycloalkyl, dicycloalkyl monoaryl or dicycloalkyl monoaryl co-catalysts. Examples of co-catalyst ligands are given in U.S. Pat. No. 4,631,315, the disclosure of which is incorporated by reference. The preferred co-catalyst ligand is triphenylphosphine. The co-catalyst ligand is preferably used in an amount in the range 0.3 to 5%, more preferably 0.5 to 4% by weight, based on the weight of the terpolymer. Preferably also the weight ratio of the rhodium-containing catalyst compound to co-catalyst is in the range 1:3 to 1:55, more preferably in the range 1:5 to 1:45.

A co-catalyst ligand is beneficial for the selective hydrogenation reaction. There should be used no more than is necessary to obtain this benefit, however, as the ligand will be present in the hydrogenated product. For instance triphenylphosphine is difficult to separate from the hydrogenated product, and if it is present in any significant quantity may create some difficulties in processing of the product.

The hydrogenation reaction can be carried out in solution. The solvent must be one that will dissolve the styrene-butadiene-nitrile rubber. This limitation excludes use of unsubstituted aliphatic hydrocarbons. Suitable organic solvents are aromatic compounds including halogenated aryl compounds of 6 to 12 carbon atoms. The preferred halogen is chlorine and the preferred solvent is a chlorobenzene, especially monochlorobenzene. Other solvents that can be used include toluene, halogenated aliphatic compounds, especially chlorinated aliphatic compounds, ketones such as methyl ethyl ketone and methyl isobutyl ketone, tetrahydrofuran and dimethylformamide. The concentration of polymer in the solvent is not particularly critical but is suitably in the range from 1 to 30% by weight, preferably from 2.5 to 20% by weight, more preferably 10 to 15% by weight. The concentration of the solution may depend upon the molecular weight of the styrene-butadiene-nitrile rubber that is to be hydrogenated. Rubbers of higher molecular weight are more difficult to dissolve, and so are used at lower concentration.

The reaction can be carried out in a wide range of pressures, from 10 to 250 atm and preferably from 50 to 100 atm. The temperature range can also be wide. Temperatures from 60 to 160°, preferably 100 to 160° C., are suitable and from 110 to 140° C. are preferred. Under these conditions, the hydrogenation is usually completed in about 3 to 7 hours. Preferably the reaction is carried out, with agitation, in an autoclave.

Although the preferred catalyst for the selective hydrogenation is a rhodium-containing catalyst, it is possible to use other catalysts. In general, many hydrogenation catalysts are known to those skilled in the art, especially catalysts of group VIII metals and complexes containing these metals. Mention is made of use of a ruthenium catalyst and a ketone solvent, as taught in U.S. Pat. No. 4,631,315, the disclosure of which is incorporated herein by reference. Also mentioned is Canadian Patent Application Serial No 2,020,012, the disclosure of which is incorporated by reference. Palladium catalysts are also mentioned as candidates for use in the selective hydrogenation.

Hydrogenation of ethylenic carbon-carbon double bonds improves various properties of the polymer, particularly resistance to oxidation. It is preferred to hydrogenate at least 80% of the ethylenic carbon-carbon double bonds present. For some purposes it is desired to eliminate all ethylenic carbon-carbon double bonds, and hydrogenation is carried out until all, or at least 99%, of the double bonds are eliminated. For some other purposes, however, some residual ethylenic carbon-carbon double bonds may be required and reaction may be carried out only until, say, 90% or 95% of the bonds are hydrogenated. The degree of hydrogenation is sometimes expressed in terms of residual double bonds (RDB), being the number of double bonds remaining after hydrogenation, expressed as a percentage of those prior to hydrogenation. Usually, the RDB is 10% or less and for some purposes it is less than 0.9%.

The degree of hydrogenation can be determined by infrared spectroscopy or ¹H-NMR analysis of the polymer. In some circumstances the degree of hydrogenation can be determined by measuring iodine value. This is not a particularly accurate method, and it cannot be used in the presence of triphenyl phosphine, so use of iodine value is not preferred.

It can be determined by routine experiment what conditions and what duration of reaction time result in a particular degree of hydrogenation. It is possible to stop the hydrogenation reaction at any preselected degree of hydrogenation. The degree of hydrogenation can be determined by ASTM D5670-95. (This test was designed for determining the degree of hydrogenation of hydrogenated nitrile rubber (HNBR), but Applicant's measurements using proton NMR measurements indicate that the test also works with (HSNBR)) See also Dieter Brueck, Kautschuk+Gummi Kunststoffe, Vol 42, No 2/3 (1989), the disclosure of which is incorporated herein by reference. The process of the invention permits a degree of control that is of great advantage as it permits the optimisation of the properties of the hydrogenated polymer for a particular utility. The degree of hydrogenation is also confirmed by proton NMR analysis.

As stated, the hydrogenation of carbon-carbon aliphatic double bonds is not accompanied by reduction of nitrile groups or carbon-carbon aromatic double bonds. As demonstrated in the examples below, 94% of the carbon-carbon aliphatic double bonds of a styrene-butadiene-nitrile rubber were reduced with no reduction of nitrile groups and carbon-carbon aromatic double bonds detectable by infrared analysis. The possibility exists, however, that reduction of nitrile groups and aromatic double bonds may occur to an insignificant extent, and the invention is considered to extend to encompass any process or product such reduction has occurred to an insignificant extent. By insignificant is meant that less than 0.5%, preferably less than 0.1%, of the nitrile groups or carbon-carbon aromatic double bonds originally present have undergone reduction.

To extract the polymer from the hydrogenation mixture, the mixture can be worked up by any suitable method. One method is to distil off the solvent. Another method is to inject steam, followed by drying the polymer. Another method is to add alcohol, which causes the polymer to coagulate.

The catalyst can be recovered by means of a resin column that absorbs rhodium, as described in U.S. Pat. No. 4,985,540, the disclosure of which is incorporated herein by reference.

The hydrogenated styrene-butadiene-nitrile rubber of the invention can be crosslinked. Thus, it can be vulcanized using sulphur or sulphur-containing vulcanizing agents, in known manner. Sulphur vulcanization requires that there be some unsaturated carbon-carbon double bonds in the polymer, to serve as reactions sites for addition of sulphur atoms to serve as crosslinks. If the polymer is to be sulphur-vulcanized, therefore, the degree of hydrogenation is controlled to obtain a product having a desired number of residual ethylenic double bonds. For many purposes a degree of hydrogenation that results in about 3 or 4% residual double bonds (RDB), based on the number of double bonds initially present, is suitable. As stated above, the process of the invention permits close control of the degree of hydrogenation.

The hydrogenated styrene-butadiene-nitrile rubber can be crosslinked with peroxide crosslinking agents, again in known manner. Peroxide crosslinking does not require the presence of double bonds in the polymer, and results in carbon-containing crosslinks rather than sulphur-containing crosslinks. As peroxide crosslinking agents there are mentioned dicumyl peroxide, di-t-butyl peroxide, benzoyl peroxide, 2,5-dimethyl-2,5-di(t-butylperoxy)-hexyne-3 and 2,5-dimethyl-2,5-di(benzoylperoxy)hexane and the like. They are suitably used in amounts of about 0.2 to 20 parts by weight, preferably 1 to 10 parts by weight, per 100 parts of rubber.

The hydrogenated styrene-butadiene-nitrile rubber of the inventioned can be compounded with any of the usual compounding agents, for example fillers such as carbon black or silica, heat stabilisers, antioxidants, activators such as zinc oxide or zinc peroxide, curing agents, co-agents, processing oils and extenders. Such compounds and co-agents are known to persons skilled in the art.

The hydrogenated styrene-butadiene-nitrile rubbers of the invention display better heat ageing resistance and better tensile strength than non-hydrogenated styrene-butadiene-nitrile rubber. Surprisingly, they also display better abrasion resistance, low temperature flexibility, and higher modulus than non-hydrogenated styrene-butadiene-rubber. These properties render them valuable for many specialised applications, but particular mention is made of use as seals in situations where severe stress is encountered, such as in high stiffness automative belts, roll covers, and hoses.

Hydrogenated nitrile rubbers (HNBR) are used in many specialised applications where difficult conditions are encountered. Surprisingly, HSNBR has a higher modulus than HNBR. Its abrasion resistance and other physical properties are comparable with HNBR. Hydrogenated styrene-butadiene-nitrile rubbers of this invention have physical properties that are superior in some respects to those of commercially available hydrogenated nitrile rubbers and hence are useful in many applications where hydrogenated nitrile rubbers are of proven utility. Mention is made of seals, especially in automotive systems and heavy equipment and any other environment in which there may be encountered high or low temperatures, oil and grease. Examples include wheel bearing seals, shock absorber seals, camshaft seals, power steering assembly seals, O-rings, water pump seals, gearbox shaft seals, and air conditioning system seals. Mention is made of oil well specialties such as packers, drill-pipe protectors and rubber stators in down-hole applications. Various belts and mountings are provided in demanding environments and the properties of hydrogenated styrene-butadiene-nitrile rubber of this invention render it suitable for applications in camshaft drive belts, oil-cooler hoses, poly-V belts, torsional vibration dampeners, boots and bellows, chain tensioning devices, and overflow caps. The high modulus and high abrasion resistance of HSNBR renders it useful for high-hardness roll applications in, for instance, metal-working rolls, paper industry rolls, printing rolls, elastomer components for looms and textile rolls.

The hydrogenated styrene-butadiene-nitrile rubber can be used in the form of a latex. Formation of a latex can be carried out by milling the hydrogenated rubber in the presence of water containing appropriate emulsifiers until the required latex is formed. Suitable emulsifiers for this purpose include anionic emulsifiers such as fatty acid soaps, i.e., sodium and potassium salts of fatty acids, rosin acid salts, alkyl and aryl sulfonic acid salts and the like. Oleate salts are mentioned by way of example. The rubber latex may be in solution in an organic solvent, or in admixture with an organic solvent, when added to the water, to form an oil-in-water emulsion. The organic solvent is then removed from the emulsion to yield the required latex. Organic solvents that can be used include the solvents that can be used for the hydrogenation reaction.

The invention is further illustrated in the following examples and in the accompanying drawings. In the examples, tests to determine properties were carried out in accordance with ASTM or DIN procedures. Of the drawings:

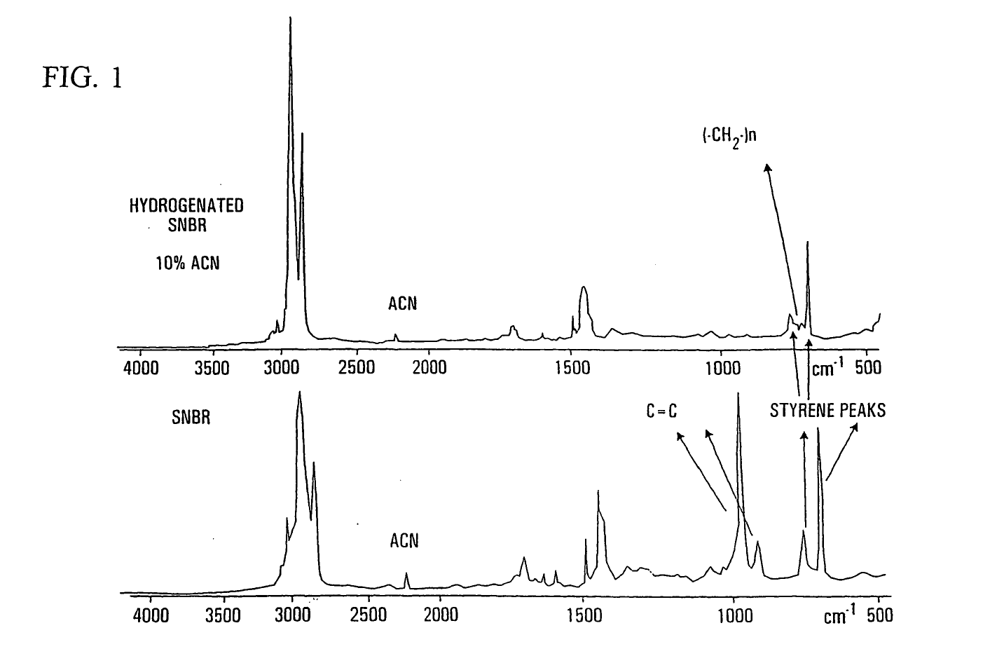

FIG. 1 is a graph showing the infrared spectrum of the polymer prior to and subsequent to hydrogenation;

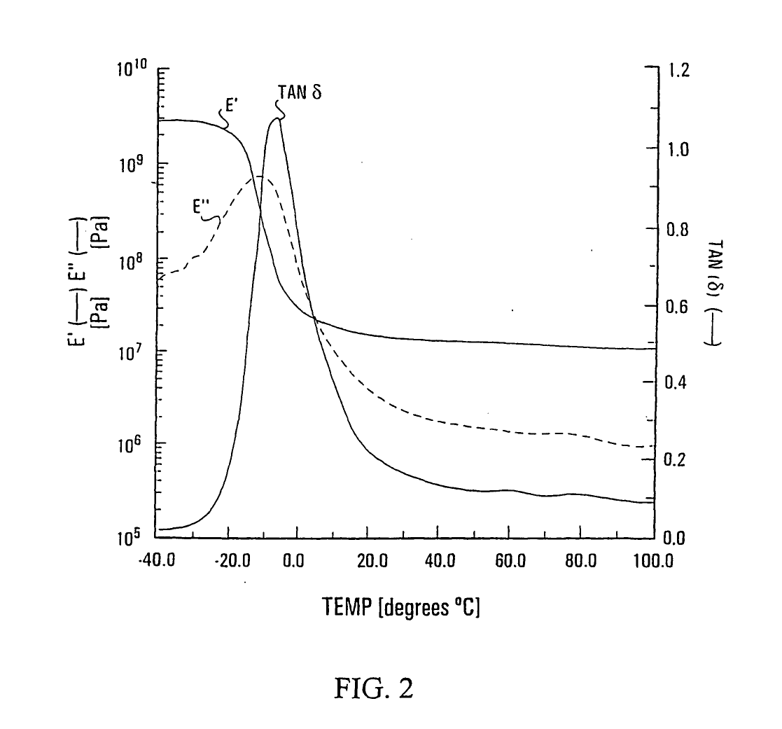

FIG. 2 is a graph of tan δ and temperature for a hydrogenated styrene-butadiene-nitrile rubber of the invention.

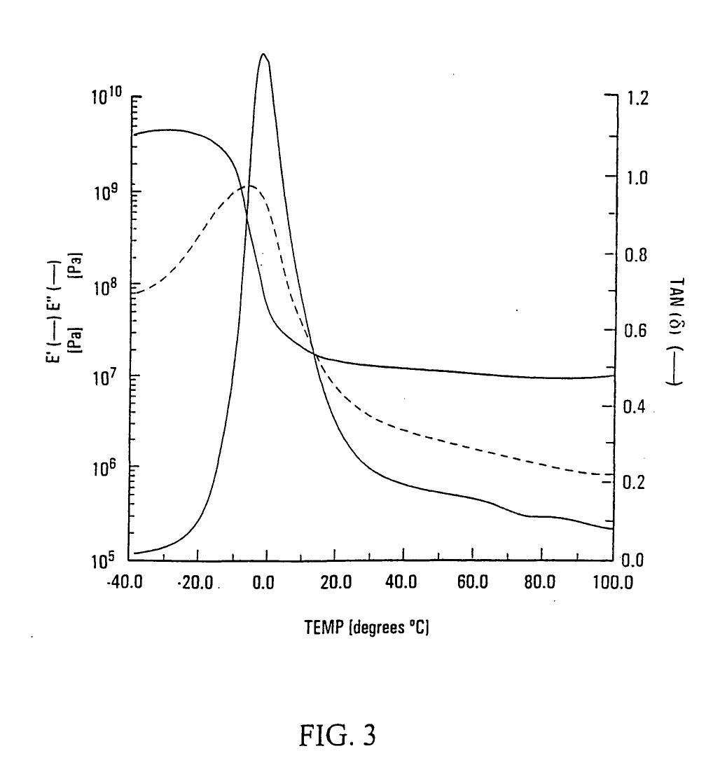

FIG. 3 is a graph of tan δ and temperature of an unhydrogenated styrene-butadiene-nitrile rubber, for purpose of comparison.

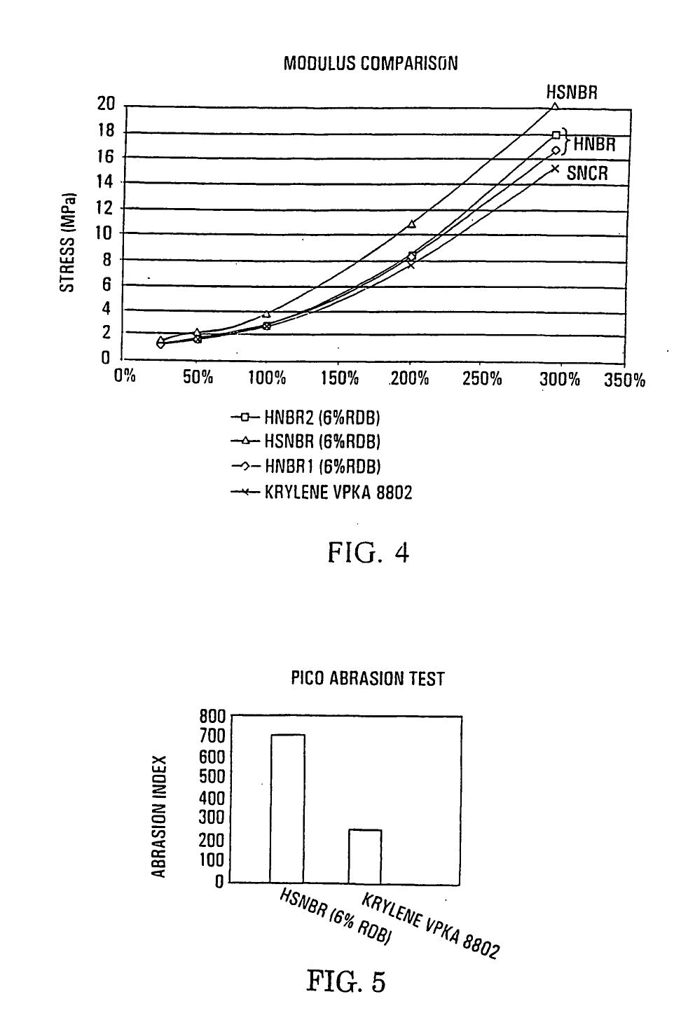

FIG. 4 is a graph of stress versus strain, showing that HSNBR has a higher modulus than two compounds of HNBR and one of SNBR; and

FIG. 5 is a graph showing results of a Pico abrasion test carried out on HSNBR of the invention and SNBR, for comparison.

### SELECTIVE HYDROGENATION OF SNBR

### EXAMPLE 1

In a lab experiment with a 12% polymer load, 392 g of a statistical styrene-acrylonitrile-butadiene terpolymer containing 20% by weight of acrylonitrile, 20% styrene, balance butadiene, ML 1+4/125° C.=25 (Krylene VPKA8802, commercially available from Bayer), in 2.9 kg of chlorobenzene was introduced into a 2 US gallon Parr high-pressure reactor. The reactor was degassed 3 times with pure H₂ (100-200 psi) under full agitation (600 rpm). The temperature of the reactor was raised to 130° C. and a solution of 0.392 g (0.1 phr) of tris-(triphenylphosphine)-rhodium-(I) chloride catalyst and 4.58 g of co-catalyst triphenylphosphine (TPP) in 60 ml of monochlorobenzene having an oxygen content less than 5 ppm was then charged to the reactor under hydrogen. The temperature was raised to 138° C. and the pressure of the reactor was set at 1200 psi (83 atm). The reaction temperature and hydrogen pressures of the reactor were maintained constant throughout the whole reaction. The degree of hydrogenation was monitored by sampling after a certain reaction time followed by Fourier Transfer Infra Red Spectroscopy (FTIR) analysis of the sample. Reaction was carried out for 180 min at 138° C. under a hydrogen pressure of 83 atmospheres. Thereafter the chlorobenzene was removed by the injection of steam and the polymer was dried in an oven at 80° C.

Samples were taken and tested for degree of hydrogenation of ethylenic double bonds. Results are given in Table 1.

TABLE 1

| | Degree of | Residual Double |
|---|---|---|
| Time (min) | hydrogenation % | Bonds (RDB) % |
| 0 | 0 | 100 |
| 60 | 95.3 | 4.7 |
| 75 | 98.5 | 1.5 |
| 180 | 99.2 | 0.8 |

The FTIR result (FIG. 1) showed that the nitrile groups and the aromatic double bonds of the polymer remained intact after the hydrogenation, indicating that the hydrogenation is selective towards the ethylenic C═C bonds only. The peak for ethylenic carbon-carbon double bonds has disappeared after hydrogenation. The peaks for the nitrile groups and for the styrene remain, indicating that there has been no detectable reduction of nitrile and aromatic double bonds.

The low temperature flexibility of the product of Example 1 and of Krylene VPKA 8802 was determined by using a Rheometrics Solid analyzer (RSA-II). In this test, a small sinusoidal tensile deformation is imposed on the specimen at a given frequency. The resulting force, as well as the phase difference between the imposed deformation and the response, are measured at various temperatures. Based on theory of linear viscoelasticity, the storage tensile modulus (E′), loss tensile modulus (E″) and tan δ can be calculated. In general, as the temperature decreases, rubber becomes more rigid, and the E′ will increase. At close to the glass transition temperature, there will be a rapid increase in E′. FIGS. 2 and 3 are graphs of the elastic modulus E′ and the viscous modulus E″ and temperature for the HSNBR product of Example 1 and for the unhydrogenated SNBR, Krylene VPKA 8802, respectively. The figures also show tan δ, which equals tan. It is desirable that the peak value of tan δ shall be as low as possible, and also that the peak value of tan δ shall occur at as low a temperature as possible. It is observed that the HSNBR is superior to the SNBR in both of these respects.

### EXAMPLE 2

In a experiment similar to Example 1, 184 g of a statistical styrene-butadiene-acrylonitrile terpolymer containing 10% by weight of acrylonitrile, 20% by weight of styrene, balance butadiene (Krylene VPKA 8683, commercially avaiable from Bayer) in 2.9 Kg chlorobenzene was introduced into a 2 US gallon Parr high-pressure reactor. The reactor was degassed 3 times with pure H₂ (100-200psi) under full agitation (600 rpm). The temperature of the reactor was raised to 138° C. and a solution of 0.376 g (0.205 phr) of tris-(triphenylphosphine)-rhodium-(I) chloride catalyst and 6.262 g (3.42 phr) of co-catalyst triphenylphosphine (TPP) in 60 ml of monochlorobenzene having an oxygen content less than 5 ppm was the charged to the reactor under hydrogen. The temperature was raised to 138° C. and the pressure of the reactor was set at 1200 psi (83 atm). The degree of hydrogenation was monitored, the reaction carried out, and the product recovered, as described in Example 1.

Samples were taken and tested for degree of hydrogenation of ethylenic double bonds. Results are given in Table 2.

TABLE 2

| | Degree of | Residual Double |
|---|---|---|
| Time (min) | hydrogenation % | Bonds (RDB) % |
| 0 | 0 | 100 |
| 60 | 62.4 | 17.6 |
| 120 | 93.9 | 6.1 |
| 150 | 95.7 | 4.3 |

### EXAMPLE 3

The hydrogenated styrene-butadiene-nitrile rubber of Example 1 was crosslinked and subjected to various tests. For purposes of comparison, the unhydrogenated styrene-butadiene-nitrile rubber (Krylene VPKA 8802) was also crosslinked and tested. Compound formulations are given in Table 3, compound Mooney Viscosities are given in Table 4, MDR cure characteristics are given in Table 5, stress-strain data after oven-aging are given in Table 6 and low temperature stiffness data are given in Table 7.

TABLE 3
Compound Formulations

| | | Krylene |
|---|---|---|
| | HSNBR (6% RDB) | VPKA 8802 |
| CARBON BLACK, N 330 | 40 | 40 |
| HSNBR (20% ACN, 6% RDB) | 100 | |
| KRYLENE VPKA 8802 (SNBR) | | 100 |
| NAUGARD 445 | 1 | 1 |
| PLASTHALL TOTM | 3 | 3 |
| STEARIC ACID | 1 | 1 |
| VULKANOX ZMB-2/C5 | 0.4 | 0.4 |
| (ZMMBI) | | |
| ZINC OXIDE (KADOX 920) | 3 | 3 |
| SPIDER SULFUR | 0.5 | 0.5 |
| VULKACIT CZ/EG-C (CBS) | 0.5 | 0.5 |
| VULKACIT THIURAM/C (D) | 2 | 2 |

NAUGARD 445 (Uniroyal) and Vulkanox ZMB-2/C5 (Bayer) are commercially available antioxidants. Plasthall TOTM (C. P. Hall) is an ester-based oil plasticiser. Vulkacit CZ/EG-C (CBS) (BAYER) is a sulfenamide curing agent and Vulkacit Thiuram/C (D) (Bayer) is a thiuram curing agent.

TABLE 4
Compound Mooney Viscosity

| | HSNBR (6% RDB) | Krylene VPKA 8802 |
|---|---|---|
| Rotor Size | large | large |
| Test Temperature (° C.) | 125 | 125 |
| Preheat Time (min) | 1 | 1 |
| Run Time (min) | 4 | 4 |
| Mooney Viscosity (MU) | 65.8 | 32.5 |
| Test Temperature (° C.) | 135 | 135 |
| Mooney Viscosity (MU) | 55.2 | 28 |

TABLE 5
MDR CURE CHARACTERISTICS

| | HSNBR (6% RDB) | Krylene VPKA 8802 |
|---|---|---|
| Frequency (Hz) | 1.7 | 1.7 |
| Test Temperature (° C.) | 170 | 170 |
| Degree Arc (°) | 1 | 1 |
| Test Duration (min) | 30 | 30 |
| Torque Range (dN.m) | 100 | 100 |
| Chart No. | 142 | 143 |
| NH (dN.m) | 36.93 | 32.92 |
| ML (dN.m) | 3.35 | 1.82 |
| Delta MH-ML (dN.m) | 33.56 | 31.1 |
| ts 1 (min) | 1.14 | 0.87 |
| ts 2 (min) | 1.38 | 0.99 |
| t′ 10 (min) | 1.54 | 1.04 |
| t′ 25 (min) | 1.89 | 1.2 |
| t′ 50 (min) | 2.23 | 1.4 |
| t′ 90 (min) | 3.76 | 2.24 |
| t′ 95 (min) | 4.85 | 2.8 |
| Delta t′50 − t′10 (min) | 0.69 | 0.36 |

TABLE 6
Stress-Strain Data After Aging

| | HSNBR (6% RDB) | Krylene VPKA 8802 |
|---|---|---|
| Cure Time (min) | 20 | 20 |
| Cure Temperature (° C.) | 170 | 170 |
| Test Temperature (° C.) | 23 | 23 |
| Ageing Time (hrs) | 504 | 504 |
| Ageing Temperature (° C.) | 135 | 135 |
| Ageing Type | air oven | air oven |
| Hardness Shore A2 (pts.) | 86 | 94 |
| Ultimate Tensile (MPa) | 22.07 | 1.65 |
| Ultimate Elongation (%) | 127 | 0 |
| Stress @ 100 (MPa) | 19.2 | |
| Stress @ 200 (MPa) | | |
| Stress @ 25 (MPa) | 4.83 | |
| Stress @ 300 (MPa) | | |
| Stress @ 50 (MPa) | 9.24 | |
| Chg. Hrd. Shore A2 | 13 | 27 |
| (pts.) | | |
| Chg. Ulti. Tens. (%) | −36 | −94 |
| Chg. Ulti. Elong. (%) | −70 | |
| Change Stress @ 100(%) | 401 | |
| Change Stress @ 200(%) | | |
| Change Stress @ 25(%) | 218 | |
| Change Stress @ 300(%) | | |
| Change Stress @ 50(%) | 330 | |

The HSNBR showed much better aging resistance than SNBR. Note, for instance, that the ultimate tensile strength of HSNBR is markedly superior to that of SNBR, and the ultimate elongation of SNBR is close to zero and could not even be measured, nor could its stress at 25 MPa, whereas stress for HSNBR was measurable up to 100 MPa.

TABLE 7
Gehman Low Temp Stiffness

| | | Krylene VPKA |
|---|---|---|
| | HSNBR (6% RDB) | 8802 |
| Cure Time (min) | 20 | 20 |
| Cure Temperature (° C.) | 170 | 170 |
| Start Temperature (min) | −50 | −50 |
| Temperature @ T2 (° C.) | −5 | −1 |
| Temperature @ T5 (° C.) | −12 | −7 |
| Temperature @ T10 (° C.) | −14 | −10 |
| Temperature @ T100 (° C.) | −24 | −17 |

In this Gehman stiffness test, lower numbers indicate better results, so it is clear that HSNBR shows better cold flexibility than SNBR.

### EXAMPLE 4

The polymer compounds used in Example 3 were crosslinked and subjected to tests as set forth below. For comparison compounds of unhydrogenated SNBR (Krylene 8802) and two commercially available hydrogenated nitrile rubbers (Therban C3467 and Therban VPKA 8830, from Bayer) were also tested. Compound formulations are given in Table 8. Tables 9 and 10 give the results obtained by subjecting the compounds to Die B and Die C tear strength tests. These tests are not particularly discriminating, but show that the two HNBR's, HSNBR and SNBR are approximately similar in tear strength. The results of measuring stress v strain are given in Table 11 and graphically in FIG. 4. Surprisingly, HSNBR is superior to both HNBR's and to SNBR.

Results of stress-strain tests after hot air oven ageing at 135° for 168 hours, 336 hours and 504 hours are given in Table 12, and demonstrate that HSNBR ages better than SNBR. Results of stress-strain tests after aging in oil and in water are in Tables 13 and 14 and, again, demonstrate the superiority of HSNBR, showing that it has good oil-resistance and good water-resistance.

Results of DIN abrasion tests and PICO abrasion tests are given in Table 15 and 16 respectively. Again, the superiority of HSNBR is demonstrated. The PICO test results are shown graphically in FIG. 5.

TABLE 8
Compound Formulations

| | HNBR (1) | HNBR (2) | HSNBR | SNBR |
|---|---|---|---|---|
| CARBON BLACK, N 330 | 40 | 40 | 40 | 40 |
| VULCAN 3 | | | | |
| HSNBR (VIA 8802) 94% | | | 100 | |
| KRYLENE VPKA 8802 | | | | 100 |
| THERBAN C 3467 | 100 | | | |
| THERBAN VP KA 8830 | | 100 | | |
| NAUGARD 445 | 1 | 1 | 1 | 1 |
| PLASTHALL TOTM | 3 | 3 | 3 | 3 |
| STEARIC ACID EMERSOL | 1 | 1 | 1 | 1 |
| 132 NF | | | | |
| VULKANOX ZMB-2/C5 | 0.4 | 0.4 | 0.4 | 0.4 |
| (ZMMBI) | | | | |
| ZINC OXIDE (KADOX 920) | 3 | 3 | 3 | 3 |
| GRADE PC | | | | |
| SPIDER SULFUR | 0.5 | 0.5 | 0.5 | 0.5 |
| VULKACIT CZ/EG-C (CBS) | 0.5 | 0.5 | 0.5 | 0.5 |
| VULKACIT THIURAM/C | 2 | 2 | 2 | 2 |
| (D) | | | | |
| Specific Gravity | 1.118 | 1.109 | 1.118 | 1.118 |

TABLE 9
Die B Tear

| | HNBR (1) | HNBR (2) | HSNBR | SNBR |
|---|---|---|---|---|
| Cure Time (min) | 20 | 20 | 20 | 20 |
| Cure Temperature (° C.) | 170 | 170 | 170 | 170 |
| Crosshead Speed (mm/min) | 500 | 500 | 500 | 500 |
| Test Temperature (° C.) | 23 | 23 | 23 | 23 |
| Tear Strength (kN/m) | 75.15 | 75.89 | 67.52 | 49.44 |
| RUN 2 | | | | |
| Cure Time (min) | 20 | 20 | 20 | 20 |
| Cure Temperature (° C.) | 170 | 170 | 170 | 170 |
| Crosshead Speed (mm/min) | 500 | 500 | 500 | 500 |
| Test Temperature (° C.) | 100 | 100 | 100 | 100 |
| Tear Strength (kN/m) | 19.16 | 18.41 | 19.42 | 20.66 |
| RUN 3 | | | | |
| Cure Time (min) | 20 | 20 | 20 | 20 |
| Cure Temperature (° C.) | 170 | 170 | 170 | 170 |
| Crosshead Speed (mm/min) | 500 | 500 | 500 | 500 |
| Test Temperature (° C.) | 150 | 150 | 150 | 150 |
| Tear Strength (kN/m) | 11.6 | 12.9 | 11.52 | 12.35 |
| RUN 4 | | | | |
| Cure Time (min) | 20 | 20 | 20 | 20 |
| Cure Temperature (° C.) | 170 | 170 | 170 | 170 |
| Crosshead Speed (mm/min) | 500 | 500 | 500 | 500 |
| Test Temperature (° C.) | 170 | 170 | 170 | 170 |
| Tear Strength (kN/m) | 9.43 | 9.71 | 9.34 | 10.75 |

TABLE 10
Die C Tear

| | HNBR (1) | HNBR (2) | HSNBR | SNBR |
|---|---|---|---|---|
| Cure Time (min) | 20 | 20 | 20 | 20 |
| Cure Temperature (° C.) | 170 | 170 | 170 | 170 |
| Test Temperature (° C.) | 23 | 23 | 23 | 23 |
| Tear Strength (kN/m) | 53.61 | 53.01 | 46.02 | 40.29 |
| RUN 2 | | | | |
| Cure Time (min) | 20 | 20 | 20 | 20 |
| Cure Temperature (° C.) | 170 | 170 | 170 | 170 |
| Test Temperature (° C.) | 100 | 100 | 100 | 100 |
| Tear Strength (kN/m) | 23.91 | 19.62 | 20.54 | 19.48 |
| RUN 3 | | | | |
| Cure Time (min) | 20 | 20 | 20 | 20 |
| Cure Temperature (° C.) | 170 | 170 | 170 | 170 |
| Test Temperature (° C.) | 150 | 150 | 150 | 150 |
| Tear Strength (kN/m) | 11.03 | 12.64 | 8.95 | 9.89 |
| RUN 4 | | | | |
| Cure Time (min) | 20 | 20 | 20 | 20 |
| Cure Temperature (° C.) | 170 | 170 | 170 | 170 |
| Test Temperature (° C.) | 170 | 170 | 170 | 170 |
| Tear Strength (kN/m) | 8.79 | 9.54 | 7.62 | 9.14 |

TABLE 11
STRESS-STRAIN

| | HNBR (1) | HNBR (2) | HSNBR | SNBR |
|---|---|---|---|---|
| Cure Time (min) | 20 | 20 | 20 | 20 |
| Cure Temperature (° C.) | 170 | 170 | 170 | 170 |
| Dumbell | die C | die C | die C | die C |
| Test Temperature (° C.) | 23 | 23 | 23 | 23 |
| Hard. Shore A2 Inst. | 69 | 69 | 73 | 67 |
| (pts.) | | | | |
| Ultimate Tensile (MPa) | 37.41 | 37.5 | 34.37 | 29.51 |
| Ultimate Elongation (%) | 484 | 451 | 425 | 469 |
| Stress @ 100 (MPa) | 2.75 | 2.8 | 3.83 | 2.75 |
| Stress @ 200 (MPa) | 8.16 | 8.45 | 10.86 | 7.56 |
| Stress @ 25 (MPa) | 1.25 | 1.31 | 1.52 | 1.18 |
| Stress @ 300 (MPa) | 16.69 | 17.87 | 20.17 | 15.08 |
| Stress @ 50 (MPa) | 1.7 | 1.76 | 2.15 | 1.67 |

TABLE 12
STRESS-STRAIN AFTER AGING IN HOT OVEN

| | HNBR (1) | HNBR (2) | HSNBR | SNBR |
|---|---|---|---|---|
| Cure Time (min) | 20 | 20 | 20 | 20 |
| Cure Temperature (°) | 170 | 170 | 170 | 170 |
| Test Temperature (° C.) | 23 | 23 | 23 | 23 |
| Ageing Time (hrs) | 168 | 168 | 168 | 168 |
| Ageing Temperature (° C.) | 135 | 135 | 135 | 135 |
| Ageing Type | air oven | air oven | air oven | air oven |
| Hardness Shore A2 (pts.) | 76 | 75 | 83 | 79 |
| Ultimate Tensile (MPa) | 31.1 | 32.79 | 25.05 | 16.76 |
| Ultimate Elongation (%) | 316 | 352 | 235 | 107 |
| Stress @ 100 (MPa) | 6.49 | 6 | 10.81 | 15.44 |
| Stress @ 200 (MPa) | 18.19 | 16.93 | 22.55 | |
| Stress @ 25 (MPa) | 1.86 | 1.85 | 2.77 | 3.84 |
| Stress @ 300 (MPa) | 29.48 | 28.15 | | |
| Stress @ 50 (MPa) | 2.92 | 2.83 | 4.89 | 7.07 |
| Chg. Hard. Shore A2 | 7 | 6 | 10 | 12 |
| (pts.) | | | | |
| Chg. Ulti. Tens. (%) | −17 | −13 | −27 | −43 |
| Chg. Ulti. Elong. (%) | −35 | −22 | −45 | −77 |
| Change Stress @ 100(%) | 136 | 114 | 182 | 461 |
| Change Stress @ 200(%) | 123 | 100 | 108 | |
| Change Stress @ 25(%) | 49 | 41 | 82 | 225 |
| Change Stress @ 300(%) | 77 | 58 | | |
| Change Stress @ 50(%) | 72 | 61 | 127 | 323 |
| RUN 2 | | | | |
| Cure Time (min) | 20 | 20 | 20 | 20 |
| Cure Temperature (° C.) | 170 | 170 | 170 | 170 |
| Test Temperature (° C.) | 23 | 23 | 23 | 23 |
| Ageing Time (hrs) | 336 | 336 | 336 | 336 |
| Ageing Temperature (° C.) | 135 | 135 | 135 | 135 |
| Ageing Type | air oven | air oven | air oven | air oven |
| Hardness Shore A2 (pts.) | 80 | 77 | 85 | 84 |
| Ultimate Tensile (MPa) | 26.5 | 29.55 | 22.19 | 16.7 |
| Ultimate Elongation (%) | 208 | 255 | 152 | <01 |
| Stress @ 100 (MPa) | 10.32 | 9.35 | 14.99 | |
| Stress @ 200 (MPa) | 25.26 | 23.33 | | |
| Stress @ 25 (MPa) | 2.54 | 2.38 | 3.94 | 11.91 |
| Stress @ 300 (MPa) | | | | |
| Stress @ 50 (MPa) | 4.48 | 4.01 | 7.11 | |
| Chg. Hard. Shore A2 | 11 | 8 | 12 | 17 |
| (pts.) | | | | |
| Chg. Ulti. Tens. (%) | −29 | −21 | −35 | −43 |
| Chg. Ulti. Elong. (%) | −57 | −43 | −64 | |
| Change Stress @ 100(%) | 275 | 234 | 291 | |
| Change Stress @ 200(%) | 210 | 176 | | |
| Change Stress @ 25(%) | 103 | 82 | 159 | 909 |
| Change Stress @ 300(%) | | | | |
| Change Stress @ 50(%) | 164 | 128 | 231 | |
| RUN 3 | | | | |
| Cure Time (min) | 20 | 20 | 20 | 20 |
| Cure Temperature (° C.) | 170 | 170 | 170 | 170 |
| Test Temperature (° C.) | 23 | 23 | 23 | 23 |
| Ageing Time (hrs) | 504 | 504 | 504 | 504 |
| Ageing Temperature (° C.) | 135 | 135 | 135 | 135 |
| Ageing Type | air oven | air oven | air oven | air oven |
| Hardness Shore A2 (pts.) | 80 | 81 | 86 | 94 |
| Ultimate Tensile (MPa) | 25.42 | 26.51 | 22.07 | 1.65 |
| Ultimate Elongation (%) | 165 | 201 | 127 | 0 |
| Stress @ 100 (MPa) | 13.17 | 11.43 | 19.2 | |
| Stress @ 200 (MPa) | | 25.48 | | |
| Stress @ 25 (MPa) | 2.93 | 2.8 | 4.83 | |
| Stress @ 300 (MPa) | | | | |
| Stress @ 50 (MPa) | 5.35 | 4.088 | 9.24 | |
| Chg. Hard. Shore A2 | 11 | 12 | 13 | 27 |
| (pts.) | | | | |
| Chg. Ulti. Tens. (%) | −32 | −29 | −36 | −94 |
| Chg. Ulti. Elong. (%) | −66 | −55 | −70 | |
| Change Stress @ 100(%) | 379 | 308 | 401 | |
| Change Stress @ 200(%) | | 202 | | |
| Change Stress @ 25(%) | 134 | 114 | 218 | |
| Change Stress @ 300(%) | | | | |
| Change Stress @ 50(%) | 215 | 132 | 330 | |

TABLE 13
STRESS-STRAIN AFTER AGING IN OIL

| | HNBR (1) | HNBR (2) | HSNBR | SNBR |
|---|---|---|---|---|
| Cure Time (min) | 20 | 20 | 20 | 20 |
| Cure Temperature | 170 | 170 | 170 | 170 |
| (° C.) | | | | |
| Ageing Time | 120 | 120 | 120 | 120 |
| (hrs) | | | | |
| Ageing | 150 | 150 | 150 | 150 |
| Temperature | | | | |
| (° C.) | | | | |
| Ageing Type | Block | Block | Block | Block |
| Ageing Medium | ASTM Oil | ASTM Oil 1 | ASTM Oil 1 | ASTM Oil 1 |
| | 1 | | | |
| Test Temperature | 23 | 23 | 23 | 23 |
| (° C.) | | | | |
| Hardness Shore | 66 | 65 | 66 | 66 |
| A2 (pts.) | | | | |
| Ultimate Tensile | 32.51 | 35.09 | 37.35 | 13 |
| (MPa) | | | | |
| Ultimate | 463 | 492 | 485 | 233 |
| Elongation (%) | | | | |
| Stress @ 25 | 1.27 | 1.22 | 1.2 | 1.23 |
| (MPa) | | | | |
| Stress @ 50 | 1.71 | 1.64 | 1.76 | 1.8 |
| (MPa) | | | | |
| Stress @ 100 | 2.76 | 2.58 | 3.08 | 3.29 |
| (MPa) | | | | |
| Stress @ 200 | 8.49 | 8.56 | 9.61 | 9.87 |
| (MPa) | | | | |
| Stress @ 300 | 17.34 | 18.62 | 19.01 | |
| (MPa) | | | | |
| Chg. Hard. Shore | −3 | −4 | −7 | −1 |
| A2 (pts.) | | | | |
| Chg. Ulti. Tens. | −13 | −6 | 9 | −56 |
| (%) | | | | |
| Chg. Ulti. | −4 | 9 | 14 | −50 |
| Elong. (%) | | | | |
| Change Stress @ | 2 | −7 | −21 | 4 |
| 25(%) | | | | |
| Change Stress @ | 1 | −7 | −18 | 8 |
| 50(%) | | | | |
| Change Stress @ | 0 | −8 | −20 | 20 |
| 100(%) | | | | |
| Change Stress @ | 4 | 1 | −12 | 31 |
| 200(%) | | | | |
| Change Stress @ | 4 | 4 | −6 | |
| 300(%) | | | | |
| Wt. Change (%) | −0.5 | −1.2 | 2.4 | −3.6 |
| Vol. Change (%) | 0.7 | −0.1 | 5.4 | −2.5 |

TABLE 14
STRESS-STRAIN AFTER AGING IN WATER

| | HNBR (1) | HNBR (2) | HSNBR | SNBR |
|---|---|---|---|---|
| Cure Time (min) | 20 | 20 | 20 | 20 |
| Cure Temperature (°) | 170 | 170 | 170 | 170 |
| Ageing Time (hrs) | 168 | 168 | 168 | 168 |
| Ageing Temperature (° C.) | 70 | 70 | 70 | 70 |
| Ageing Type | Block | Block | Block | Block |
| Ageing Medium | Water | Water | Water | Water |
| Test Temperature (° C.) | 23 | 23 | 23 | 23 |
| Hardness Shore A2 (pts.) | 71 | 67 | 71 | 65 |
| Ultimate Tensile (MPa) | 34.8 | 36.09 | 34.56 | 26.29 |
| Ultimate Elongation (%) | 434 | 413 | 408 | 415 |
| Stress @ 25 (MPa) | 1.28 | 1.33 | 1.51 | 1.23 |
| Stress @ 50 (MPa) | 1.82 | 1.85 | 2.19 | 1.81 |
| Stress @ 100 (MPa) | 3.2 | 3.19 | 4.07 | 3.38 |
| Stress @ 200 (MPa) | 9.95 | 10.17 | 11.88 | 9.71 |
| Stress @ 300 (MPa) | 19.49 | 20.94 | 22.02 | 17.47 |
| Chg. Hard. Shore A2 | 2 | −2 | −2 | −2 |
| (pts.) | | | | |
| Chg. Ulti. Tens. (%) | −7 | −4 | 1 | −11 |
| Chg. Ulti. Elong. (%) | −10 | −8 | −4 | −12 |
| Change Stress @ 25(%) | 2 | 2 | −1 | 4 |
| Change Stress @ 50(%) | 7 | 5 | 2 | 8 |
| Change Stress @ 100(%) | 16 | 14 | 6 | 23 |
| Change Stress @ 200(%) | 22 | 20 | 9 | 28 |
| Change Stress @ 300(%) | 17 | 17 | 9 | 16 |
| Wt. Change (%) | 0.5 | 0.6 | 1.3 | 4 |
| Vol. Change (%) | 0.3 | 0.3 | 2.2 | 4.7 |

TABLE 15
DIN ABRASION

| | HNBR (1) | HNBR (2) | HSNBR | SNBR |
|---|---|---|---|---|
| Cure Time (min) | 170 | 170 | 170 | 170 |
| Cure Temperature (° C.) | 25 | 25 | 25 | 25 |
| Specific Gravity | 1.11 | 1.115 | 1.125 | 1.145 |
| Abrasion Volume Loss (mm³) | 70 | 64 | 99 | 119 |

TABLE 16
PICO ABRASION

| | HNBR (1) | HNBR (2) | HSNBR | SNBR |
|---|---|---|---|---|
| Cure Time (min) | 20 | 20 | 20 | 20 |
| Cure Temperature (° C.) | 170 | 170 | 170 | 170 |
| Revolution | 80 | 80 | 80 | 80 |
| Specific Gravity | | | | |
| Severity | STD | STD | STD | STD |
| Abrasion Volume Loss | 0.0038 | 0.003 | 0.0029 | 0.0079 |
| (cm³) | | | | |
| Abrasive Index | 526.71 | 702.81 | 730.93 | 268.64 |

1. A polymer of a vinyl aromatic compound, a conjugated diene and an unsaturated nitrile that has been selectively hydrogenated to reduce ethylenic carbon-carbon double bonds without concomitant hydrogenation of nitrile groups and aromatic carbon-carbon double bonds.

2. A polymer according to claim 1, wherein the vinyl aromatic compound is styrene, alpha-methylstyrene, either of which is optionally substituted in the para position of the phenyl ring by a lower alkyl group.

3. A polymer according to claim 1 or 2, wherein the conjugated diene is 1,3-butadiene, isoprene, 2,3-dimethyl-1,3-butadiene, 1,3-pentadiene or piperylene.

4. A polymer according to claim 1, 2 or 3, wherein the unsaturated nitrile is acrylonitrile or methacrylonitrile.

5. A polymer according to any one of claims 1 to 4, wherein the number of residual ethylenic carbon-carbon double bonds is (RDB) is less than 10% of the ethylenic carbon-carbon double bonds prior to hydrogenation.

6. A polymer according to claim 5, wherein the RDB is less than 0.9%.

7. A process for preparing a polymer according to any one of claims 1 to 6, which comprises selectively hydrogenating a polymer of a vinyl aromatic monomer, a conjugated diene and an unsaturated nitrile to reduce ethylenic carbon-carbon double bonds without concomitant reduction of nitrile groups and aromatic carbon-carbon double bonds.

8. A process according to claim 7, wherein the selective hydrogenation is carried out with a rhodium-containing catalyst.

9. A polymer according to any one of claims 1 to 6 in crosslinked form.
